(19) United States
(12) Patent Application Publication
(10) Pub. No.: US 2010/0060652 A1
(43) Pub. Date: Mar. 11, 2010

(54) GRAPHICS RENDERING SYSTEM

(76) Inventors: Tomas Karlsson, Ranea (SE); Lasse Wedin, Lulea (SE); Johan Lindbergh, Lulea (SE)

Correspondence Address: MOORE & VAN ALLEN PLLC, P.O. BOX 13706, Research Triangle Park, NC, 27709, US

(21) Appl. No.: 12/531,842

(22) PCT Filed: Feb. 20, 2008
(86) PCT No.: PCT/SE08/50196

§ 371 Date: Sep. 17, 2009

Related U.S. Application Data
(60) Provisional application No. 60/908,801, filed on Mar. 29, 2007.

(30) Foreign Application Priority Data
Mar. 28, 2007 (SE) 0700783-4

(51) Int. Cl. G06T 1/00

(52) U.S. Cl. 345/522

(57) ABSTRACT

A graphics processing solution wherein operator-generated commands concerning a data structure describing a graphics scene are received via an user interface associated with a client module. Based on the commands, the client module produces at least one set of data resources and at least one instruction set. Each resource in the set of data resources represents a given graphical content of the scene, and the instruction set describes interrelationships between these resources. The client module is adapted to transfer the data resources and instruction sets to a server module. The server module is associated with a memory means having at least one data area which each is adapted to store an amount of data relating to a given context of the scene. Each amount of data is organized as a set of data resources and an instruction set, which may have a different format than the data resources and instruction sets produced in the client module. The server module implements at least one rendering kernel configured to generate a visual output data based on the set of data resources and the instruction set. The visual output data represents a projection of the scene onto a two-dimensional graphics display and has a format adapted for presentation on the graphics display.

### THE BACKGROUND OF THE INVENTION AND PRIOR ART

The present invention relates generally to rendering of computer graphics. More particularly the invention relates to a rendering system according to the preamble of claim 1 and a method according to claim 15. The invention also relates to a computer program according to claim 23 and a computer readable medium according to claim 24.

Graphics rendering is the process of generating an image from a model by means of computer programs. The resulting image is a digital image, i.e. a two-dimensional data representation in the form of a finite set of digital values called picture elements, or pixels. The underlying model is a description of three-dimensional (3D) objects in a strictly defined data structure, for example represented by a scene graph. The data structure typically contains information regarding geometry, viewpoint, texture and lighting. The rendering process is effected as a last main step in the graphics pipeline in order to create a final appearance of said model and any animation associated thereto. Rendering graphics may be employed in video games, simulators, design visualization and in moving pictures and TV productions, predominantly as special effects.

Today, a wide variety of rendering products are available. Various rendering software is integrated into larger modeling and animation packages, while other solutions are offered as stand-alone products. 3D graphics may be pre-rendered, partially or entirely, or it may be performed fully in real-time. Pre-rendering is primarily employed in connection with computationally intensive tasks where no time constraints apply (e.g. in movie creation), whereas real-time rendering often is used in 3D video games, which rely on graphics cards having 3D hardware accelerators.

U.S. Pat. No. 6,570,564 describes a solution for rapid processing of scene-graph based data and/or programs. Here, a parallel structure for the scene-graph is produced, which adapts the data for parallel processing in computer systems including multiple CPUs. As a result, repeated traversals of the scene graph's hierarchy can be avoided.

Although the above approach may be technically efficient, it requires a particular combination of API (Application Program Interface) and data structure (i.e. scene graph). Of course, this is disadvantageous from a flexibility point-of-view. Open standards, such as COLLADA (Collaborative Design Activity) and X3D (the ISO standard for real-time 3D computer graphics), provide a much larger flexibility. However, neither of these standards specifies a rendering order. Therefore, the standards provide a low degree of user control with respect to the final onscreen result. Hence, a user cannot create graphics with a specified rendering order, and at the same time, work within the scope of existing open standards. Moreover, even if the user sacrifice the open-standard compatibility, modifying the rendering algorithm to attain a specified result is a fairly complex task.

### SUMMARY OF THE INVENTION

The object of the present invention is therefore to provide a solution, which solves the above problems thus offers a graphics processing tool wherein the user can control the rendering order of a data structure which complies with an open standard.

According to one aspect of the invention, the object is achieved by the system as initially described, wherein the system includes a client module and a server module. The client module is adapted to receive operator-generated commands and based thereon produce at least one set of data resources and at least one instruction set. Each resource in the set of data resources represents a given graphical content of the graphics scene (for example embodied in a transform matrix, a mesh, a texture and/or a shader) and the at least one instruction set describes interrelationships between the resources in the set of data resources. The client module is further adapted to transfer the data resources and the at least one instruction set to the server module. The server module, in turn, is associated with a memory means having at least one data area, which each is adapted to store an amount of data relating to a given context of the scene. For example, one data area may be exclusively associated with a given client module. In any case, each amount of data is organized as a set of data resources and an associated instruction set. Moreover, the server module implements at least one rendering kernel configured to generate the visual output data based on the set of data resources and the instruction set. The visual output data, which represents a two-dimensional projection of the scene, has a format that is adapted for presentation on the graphics display.

This system is advantageous because the proposed client-server module concept allows the data structure to comply with a given open standard (i.e. on the client side) while also allowing a structure (i.e. on the server side), which is adapted to a special-purpose and/or special effect rendering kernel. Furthermore, the separated rendering kernel highly facilitates the process of designing new and original rendering features. In fact, accomplishing a new rendering kernel that is compatible with pre-modeled data from a conventional DCC (Digital Content Creation) tool becomes a straightforward undertaking.

According to one preferred embodiment of this aspect of the invention, the server module is adapted to receive the instruction set and the set of data resources on at least one first respective predefined format (e.g. compliant with COLLADA). The server module is further adapted to convert at least one of the instruction set and the set of data resources into a second format (e.g. adapted to allow variations in the characteristics of the rendering kernel). The server module is also configured to store the converted data in the memory means. Preferably, the server module is adapted to generate the visual output data contemporaneously with converting the instruction set and the set of data resources into the second format. Hence, the graphics data can be processed in a highly efficient manner.

According to another preferred embodiment of this aspect of the invention, the server module includes a user interface specifically adapted to enable modification of the rendering kernel into a customized version of the rendering kernel. Additionally, the set of data resources and the instruction set stored in the memory means of the server module are organized in a data structure being adapted to be interoperable with the customized version of the rendering kernel. Naturally, this further facilitates any future rendering kernel design.

According to still another preferred embodiment of this aspect of the invention, the client module is adapted to perform the following procedure in response to the operator-generated command. First, it is investigated whether or not the command represents at least one data resource in addition to any data resources having been previously transferred from the client module to the server module for inclusion into at least one of the at least one set of data resources. Only if it is found that the command represents at least one such additional data resource the at least one data resource is transferred to the server module. As a result, the average bandwidth requirements between the client module and the server module can be held relatively low. This is desirable irrespective of whether both the client module and the server module are implemented in a common data-processing apparatus, as in one preferred embodiment of this aspect of the invention, or if the client module is implemented in a first data-processing apparatus and the server module is implemented in a second data-processing apparatus, as in another preferred embodiment of this aspect of the invention.

According to yet another preferred embodiment of this aspect of the invention, the system includes at least two client modules implemented in a respective data-processing apparatus. Each of these modules is adapted to transfer data resources and instructions to a data-processing apparatus implementing the server module. Hence, a number of different users may work in a common graphics environment, either by being responsible for different aspects of the same scene, or by designing separate scenes.

According to another preferred embodiment of this aspect of the invention, the system includes at least two server modules implemented in a respective data-processing apparatus. Each server module is adapted to receive data resources and instructions from at least one client module. I.e. one client module may transmit sets of data resources and instruction sets to two or more server modules, or two or more client modules may transmit such information to two or more server modules. Thereby, a high flexibility is attained with respect to both implementation and the use of processing resources.

According to a further preferred embodiment of this aspect of the invention, it is presumed that the graphics scene includes at least one renderable entity. Moreover, at least one instruction in one of the instruction sets is adapted to describe a forming of the at least one renderable entity in the visual output data based on a set of data resources. Preferably, the instructions in the instruction sets are categorized into local and global instructions respectively. The local instructions are adapted to influence a specifically identified subset of data resources in a set of the data resources, and the global instructions are adapted to influence all data resources in the graphics scene. Thus, for example, a first client module may produce a general type of instructions in respect of a scene that will also affect the final result of a more specific set of instructions produced by a second client module.

According to another preferred embodiment of this aspect of the invention, a first data resource in a first set of data resources stored in the server module is configured to be shared with a second data resource in a second set of data resources stored in the server module. The first and second data resources here represent the same graphical content of the scene. However, this content is associated with different instruction sets, for example created by users of different client modules. This function is advantageous because it allows efficient reuse of instructions forwarded to the server module.

According to another aspect of the invention, the object is achieved by a method of processing computer graphics, which involves receiving operator-generated commands concerning a data structure describing a graphics scene via at least one user interface associated to a client module. The method further involves producing at least one set of data resources and at least one instruction set based on the received commands. Each resource in the at least one set of data resources represents a given graphical content of the scene and each instruction set describes interrelationships between the resources in the set of data resources. Subsequently, the method involves transferring the data resources and the at least one instruction set from the client module to a server module. Then, the data resources and the instructions are organized in a memory means of the server module in at least one data area such that each data area contains an amount of data which relates to a given context of the scene. The data is organized as a set of data resources and an instruction set associated thereto. Finally, the visual output data is generated based on the set of data resources and the instruction set by means of at least one rendering kernel in the server module. The visual output data here has a format that is adapted for presentation on the graphics display. The advantages of this method, as well as the preferred embodiments thereof, are apparent from the discussion hereinabove with reference to the proposed system.

According to a further aspect of the invention the object is achieved by a computer program, which is loadable into the internal memory of a computer, and includes software for controlling the above proposed method when said program is run on a data-processing apparatus.

According to another aspect of the invention the object is achieved by a computer readable medium, having a program recorded thereon, where the program is to control a data-processing apparatus to perform the above proposed method.

Further advantages, advantageous features and applications of the present invention will be apparent from the following description and the dependent claims.

### BRIEF DESCRIPTION OF THE DRAWINGS

The present invention is now to be explained more closely by means of preferred embodiments, which are disclosed as examples, and with reference to the attached drawings.

FIG. 1 shows an overview of a rendering system according to one embodiment of the invention;

FIGS. 2a-c illustrate client- and server-module configurations according to different embodiments of the invention;

FIG. 3 exemplifies a simulation implementation according to one embodiment of the invention; and

FIG. 4 illustrates, by means of a flow diagram, a general method of processing computer graphics according to the invention.

### DESCRIPTION OF PREFERRED EMBODIMENTS OF THE INVENTION

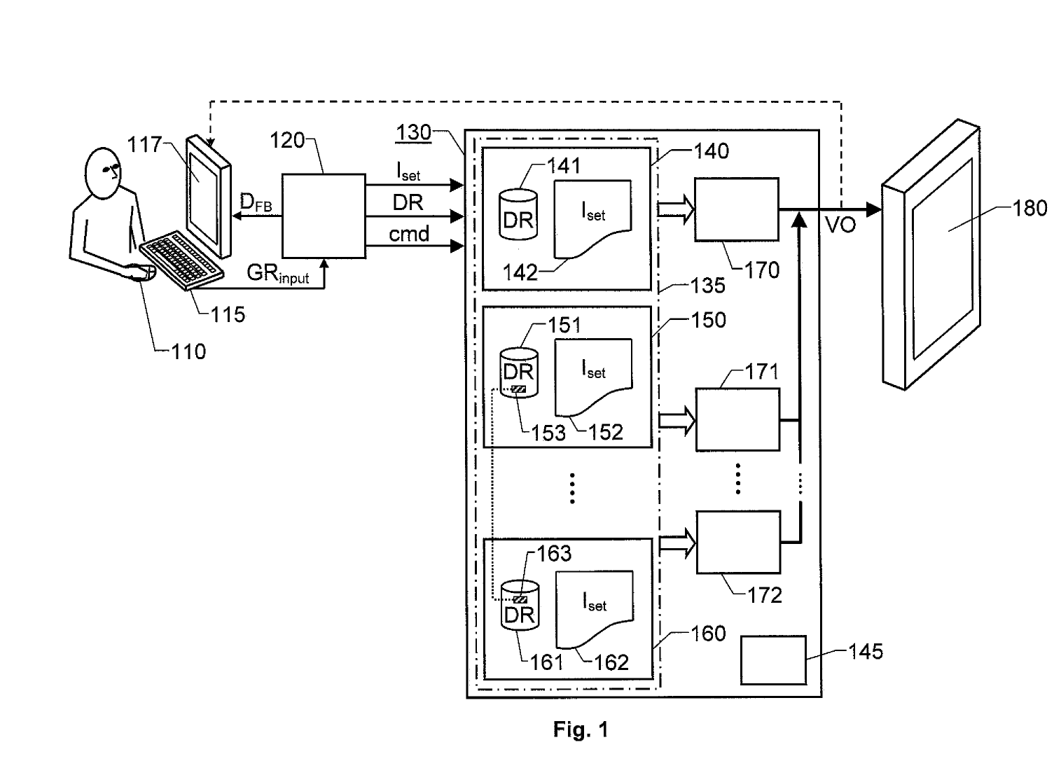

We refer initially to FIG. 1, which shows an overview of a graphics processing system according to one embodiment of the invention. The system includes at least one user interface 110, 115 and 117, at least one client module 120, at least one server module 130 and at least one two-dimensional graphics display 180.

The at least one user interface is adapted to receive operator-generated commands GRᵢₙₚᵤₜ concerning a data structure describing a graphics scene. To this aim, the interface may include a cursor manipulating means 110 (e.g. a desktop mouse, a touch pad, a joyball or a joystick) and keyboard 115. The user interface preferably also includes a display means 117 adapted to present relevant feedback data to a user of the system. Furthermore, the display means 117 may be combined with a data input means, e.g. a touch screen representing the keyboard 115.

The user interfaces 110, 115 and 117 are associated with the client module 120, which is implemented in a data-processing apparatus, e.g. a work station, a personal computer, a laptop, or other portable device such as a mobile telephone or a PDA (Personal Digital Assistant). The client module 120 is adapted to receive the operator-generated commands GRᵢₙₚᵤₜ. Based on the commands GRᵢₙₚᵤₜ, the client module 120 is adapted to produce at least one set of data resources DR and at least one instruction set Iₛₑₜ. Preferably, the set of data resources DR and the instruction sets Iₛₑₜ conform to an existing open standard, such as COLLADA or X3D. This means that the client module 120 may include a DCC tool in the form of Maya, 3D Studio Max, Softimage XSI, or Blender. Each resource in the set of data resources DR represents a given graphical content of a graphics scene, and each instruction set Iₛₑₜ describes interrelationships between the resources in the set of data resources DR. The client module 120 is adapted to transfer the data resources DR and the at least one instruction set Iₛₑₜ to the server module 130 via an appropriate channel (e.g. an internal bus, a network connection, a wireless interface, or a combination thereof) depending on whether the client module 120 and the server module 130 are implemented in a common data-processing apparatus, or if they are implemented in separate apparatuses.

In addition to said sets of data resources DR and instruction sets Iₛₑₜ the client module 120 is preferably adapted to transfer commands cmd to the server module 130. These commands cmd may represent parameter settings, such as an amount of memory to be allocated in the server module 130, a display resolution to be used etc. The server module 130 is adapted to receive the sets of data resources DR, the instruction sets Iₛₑₜ and any commands cmd from the client module 120.

The server module 130 is associated with a memory means 135. This means that the server module 130 either includes the memory means 135, or has a communication link to an external resource including the memory means 135. In any case, the memory means 135 has at least one data area symbolized 140, 150 and 160 respectively in FIG. 1. Each of the data areas 140, 150 and 160 is adapted to store an amount of data that is related to a given context of the graphics scene. Further, if more than one client module 120 is linked to the server module 130, a given data area may be exclusively associated with a particular client module 120.

Each amount of data, in turn, is organized as a set of data resources 141, 151, and 161 respectively, and an instruction set associated thereto 142, 152 and 162 respectively. As mentioned above, each resource in the set of data resources 141, 151 and 161 represents a given graphical content of the graphics scene. Thus, the data resources may embody a transform matrix, a mesh, a texture, a shader etc.

The server module 130 functions as a general container for commands cmd, instruction sets Iₛₑₜ and data resources DR. Furthermore, the server module 130 is adapted to manage allocation of the memory means 135 and threading behavior. Additionally, the server module 130 is adapted to act as control point for managing rendering and contexts in one or more graphics scenes.

According to one preferred embodiment of the invention, the server module 130 is adapted to receive the instruction sets Iₛₑₜ and the sets of data resources DR on a first respective predefined format, and convert at least one of the instruction sets Iₛₑₜ and the sets of data resources DR into a second format. More preferably, the server module 130 is further adapted to generate visual output data VO contemporaneously with converting the instruction set 142, 152 and/or 162 and/or the set of data resources 141, 151 and/or 161 into the second format. Namely thereby, the graphics data can be processed very efficiently. The server module 130 may effect this parallel processing by running multiple threads either on a single-core processor, or by employing two or more processing cores.

After conversion, the server module 130 is adapted to store the converted data in the memory means 135. Consequently, the sets of data resources 141, 151 and 161 may have a format different from the format of the sets of data resources DR generated in the client module 120. For example, an incoming mesh resource from the client module 120 may be converted into a structure suitable for real-time rendering for OpenGL or Direct3D. Thus, the resource can be rendered at optimal speed by a rendering element, such as a rendering kernel 170, 171 or 172.

Each rendering kernel 170, 171 and 172 of the server module 130 is adapted to produce visual output data VO that represents a projection of the graphics scene onto the two-dimensional graphics display 180, which is connected to the server module 130, either directly or indirectly via a network. The graphics scene typically includes a number of renderable entities. This means that an instruction in an instruction set, say 142, describes, based on its associated set of data resources 141, the forming of one of said renderable entities in the visual output data VO.

A given kernel, say 170, is configured to generate the visual output data VO based on the set of data resources 141, 151 or 161 and the instruction set 142, 152 or 162 according to a particular rendering algorithm, which is designed to accomplish a specified visual result. According to the invention, the server module 130 may include two or more different kernels 170, 171 and 172, which each is adapted for a specific purpose.

The rendering kernel 170, 171 or 172 is responsible for interpreting the meaning of the graphics scene and create a representative visual output. The kernel may both be invoked on a single context, or on a list of several contexts, thus combining a complete output from a multitude of client modules 120.

According to one preferred embodiment of the invention, the server module 130 also includes a user interface adapted to enable modification of the rendering kernels 170, 171 or 172 into a customized version of the kernel. Moreover, the set of data resources 141, 151 and 161 and the instruction set 142, 152 and 162 stored in the data area of the memory means 135 are organized in a data structure, which is adapted to be interoperable with the customized version of the rendering kernel. This gives a developer unique possibilities to extend and/or reshape the meaning of a scene without changing the logic of the application, or the interface between a client and application. The developer also gains full control of the rendering process, and can thus express any rendering algorithm, which increases performance within the scope of the system without changing the client traversal or the need to introduce custom proprietary changes to standardized structures, e.g. on the COLLADA-format or to the sever architecture and its internal mechanism. The invention thereby allows multiple rendering kernels to be loaded in parallel in the server module 130. For example, a first of these kernels may be an original kernel, a second may be a customized version thereof, a third may be a third-party plug-in, and so on.

Below follows an illustrating example. According to the invention, a dedicated rendering kernel may be based on an animated COLLADA 1.4.1 of a island with both over- and underwater geometry and animated human characters. To this scene a custom HDR—(high dynamic range) and water rendering kernel can be developed, where the water rendering includes surface animation, realistic rippling distortion effects and advanced physics-based light effects including light being both reflected and refracted in the water. The rendering of water also includes a murkiness factor, which gives realistic water depth perception of any submerged geometry. The kernel adds HDR rendering techniques combined with tone mapping and lens effects, such as blur and glares, which allows the water to shimmer as the result of interaction with the surrounding sky. The COLLADA 1.4.1 common specification does not include the possibility to add water, water animation and information how water should be rendered and interact with the environment, nor sufficient parameters to control it. According to the invention, however, water can be added as a rendering-kernel property, thus adding detail to a scene in a manner previously impossible.

Irrespective of which rendering kernel 170, 171 or 172 that is employed, the visual output data VO has a format adapted for presentation on the graphics display 180. For practical reasons, it is often useful to also feedback the visual output data VO to the display means 117 associated with the client module 120 (i.e. for presentation to the user/developer).

Although it may be generally advantageous to implement the instruction sets 142, 152 and 162 in a CPU (Central Processing Unit) and to implement the rendering kernels 170, 171 and 172 in a GPU (Graphics Processing Unit), it is worth mentioning that other implementations are conceivable according to the invention. For instance, depending on the characteristics of the rendering relative to the capacity of the data-processing apparatus(es), both the instruction sets and the kernels may be implemented in the CPU, or conversely both the instruction sets and the kernels may be implemented in the GPU.

To economize the bandwidth of the interface between the client module 120 and the server module 130, according to one preferred embodiment of the invention, the client module 120 is adapted to apply the following procedure in response to the operator-generated command GRᵢₙₚᵤₜ. First, it is investigated whether or not a received command GRᵢₙₚᵤₜ represents at least one data resource DR in addition to any data resources that have been previously transferred from the client module 120 to the server module 130 for inclusion into at least one of the at least one set of data resources 141, 151 and 161 respectively. Only if it is found that the command GRᵢₙₚᵤₜ represents at least one such additional data resource, relevant data resources DR are transferred to the server module 130 (i.e. previously unsent data). Due to this design of the rendering protocol it is possible to receive real time output over a network having relatively limited bandwidth. For a typical scene of static scenery, a set of rigid objects and skinned character such human only 4×4 matrix, 64 byte need to be communicated over the network at runtime for each moved object. This produces a very reasonable the network load, especially as compared to other network enabled techniques, e.g. OpenGL and Java3D.

According to one preferred embodiment of the invention, the instructions in the instruction sets 142, 152 and 162 are categorized into local instructions and global instructions respectively. The local instructions are adapted to influence a specifically identified subset of data resources in a set of the data resources 141, 151 or 161. The global instructions, on the other hand, are adapted to influence all data resources in the graphics scene.

Moreover, the protocol implemented by the server module 130 is preferably context aware and adapted to allow multiple types of client data structures and APIs to be integrated into one type of visual output data VO. Thereby, the client module 120 can receive a mix of several different file formats, and by using a respective dedicated API, combine these file formats into single visual experience. For example this functionality is useful in GIS/GIT applications, wherein a streaming map API is to be combined with a plurality of different graphic scenes (e.g. defined in COLLADA) containing renderable objects (GIS=Geographic Information System; GIT=Geographic Information Technology).

According to one preferred embodiment of the invention, a first data resource 153 in a first set of data resources 151 is configured to be shared with a second data resource 163 in a second set of data resources 161. This means that the first and second data resources 153 and 163 represent the same graphical content of the scene, however this content is associated with different instruction sets, namely 152 and 162 respectively.

Preferably, the server module 130 is adapted to automatically share external referenced resources (e.g. in the form of textures and shaders) a between different contexts (i.e. represented by different data resources 143, 153 or 163). When a client module 120 disconnects from the server module 130, the sever module 130 is configured to automatically free all data resource assigned to this client module 120, thus preventing memory leaks. However, any shared resources 153 and 163 will only fall out of scope when they are freed from all the contexts into which they have been included. This architecture provides unique possibilities to work with a multitude of clients of different origins without risking resources conflicts, or memory bloat due to ineffective memory management of allocated resources. At the same time, the risk for memory leaks is eliminated.

The server module 130 is preferably associated with a computer readable medium 145 (e.g. a memory module) having a program recorded thereon. Said program is configured to make the data-processing apparatus in which the server module 130 is implemented control above-described procedure.

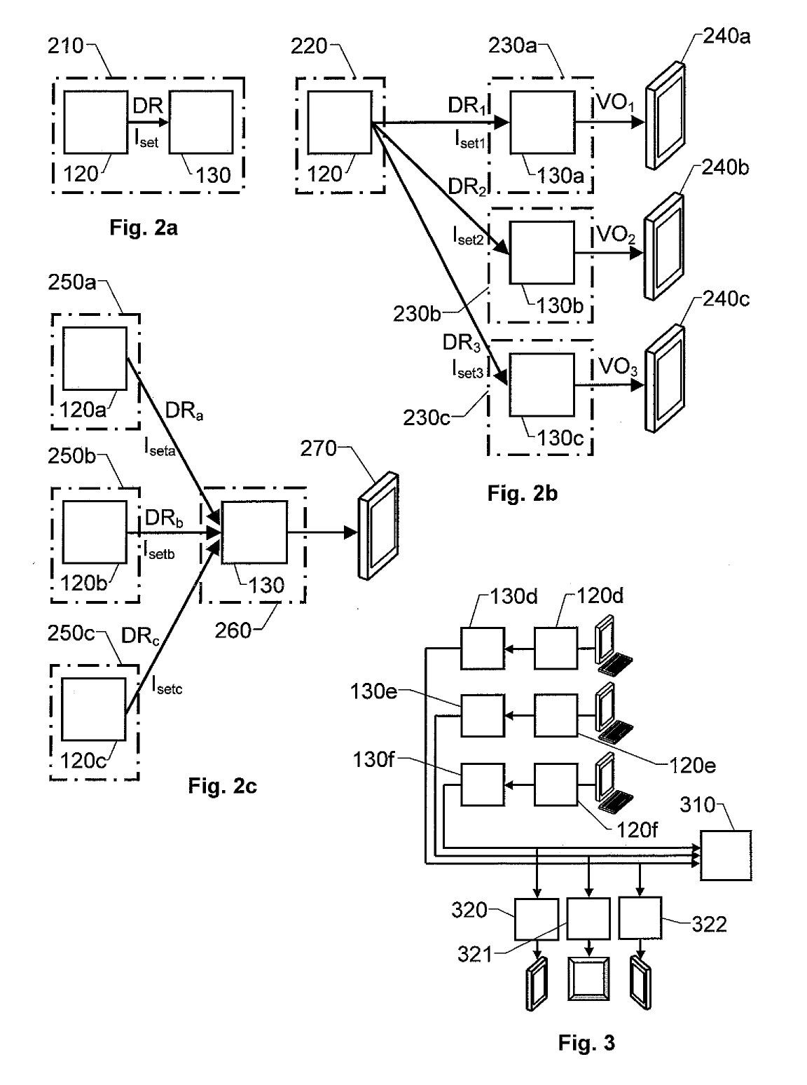

FIG. 2a illustrates a client- and server-module configuration according to a first embodiment of the invention, wherein the client module 120 and the server module 130 are implemented in a common data-processing apparatus 210, e.g. a work station, a personal computer, a laptop, PDA, a smartphone or a mobile telephone. This implementation is suitable for a single-user environment.

FIG. 2b illustrates a client- and server-module configuration according to a second embodiment of the invention. Here, the client module 120 is implemented in a first data-processing apparatus 220 and the server module 130 is implemented in second data-processing apparatuses 230a, 230b and 230c respectively. Alternatively, two or more of the data-processing apparatuses 230a, 230b and 230c may be represented by different processor cores of a single apparatus. In any case, the client module 120 is adapted to transfer a first set of data resources DR₁ and a first instruction set Iₛₑₜ₁ to a first server module 130a implemented in a primary data-processing apparatus 230a to produce a first visual output VO₁; transfer a second set of data resources DR₂ and a second instruction set Iₛₑₜ₂ to a second server module 130b implemented in a secondary data-processing apparatus 230b to produce a second visual output VO₂; and transfer a third set of data resources DR₃ and a third instruction set Iₛₑₜ₃ to a server module 130c implemented in a ternary data-processing apparatus 230c to produce a third visual output VO₃. Either two or more of the visual outputs VO₁, VO₂ and VO₃ may be mixed into a combined presentation on a single display means, or each of the outputs VO₁, VO₂ and VO₃ may be presented on a respective display means 240a, 240b and 240c as illustrated in FIG. 2b. This embodiment is advantageous for especially processing demanding tasks where load sharing may be required.

FIG. 2c illustrates a client- and server-module configuration according to a third embodiment of the invention. Here, a number of client modules 120a, 120b and 120c are implemented in a respective data-processing apparatus 250a, 250b and 250c. Each client module 120a, 120b and 120c is adapted to transfer data resources DRₐ, DR_{b} and DR_{c} respectively and instructions Iₛₑₜₐ, I_{setb} and I_{setc} respectively to a data-processing apparatus 260 implementing a common server module 130. This embodiment is desirable when a plurality of users shall cooperate to create a graphics environment in a comparatively powerful data-processing apparatus. The different data resources DRₐ, DR_{b} and DR_{c} respectively and instructions Iₛₑₜₐ, I_{setb} and I_{setc} may either a common scene or different scenes in the graphics environment.

Naturally, according to the invention, various forms of combinations, or hybrids, between the embodiments described above with reference to FIGS. 2a, 2b and 2c are conceivable. For example, the proposed system may include two or more server modules 130 implemented in a respective data-processing apparatus, each of the server modules may be adapted to receive data resources and instructions from more than one client module 120.

FIG. 3 illustrates one embodiment of the invention, which implements a so-called CAVE (Cave Automatic Virtual Environment) system, i.e. an immersive virtual reality environment where a number of display means (normally projectors) are arranged to show moving images on the walls of a room-sized cube, or similar. Thus, a highly realistic simulation can be created. Here, each module 120d, 120e and 120f in a set of client modules drives a respective portion of the simulation via a dedicated server module 130d, 130e and 130f respectively, such that each display means shows viewing from a different camera angle. A coordinating processor 310 and dedicated subsequent processing means 320, 321 and 322 may also be required.

A similar setup can be utilized in a multi pass algorithm where each server module 130d, 130e and 130f is adapted to execute independent render passes on a respective data-processing apparatus. A combined data stream is then rendered into a single visual output.

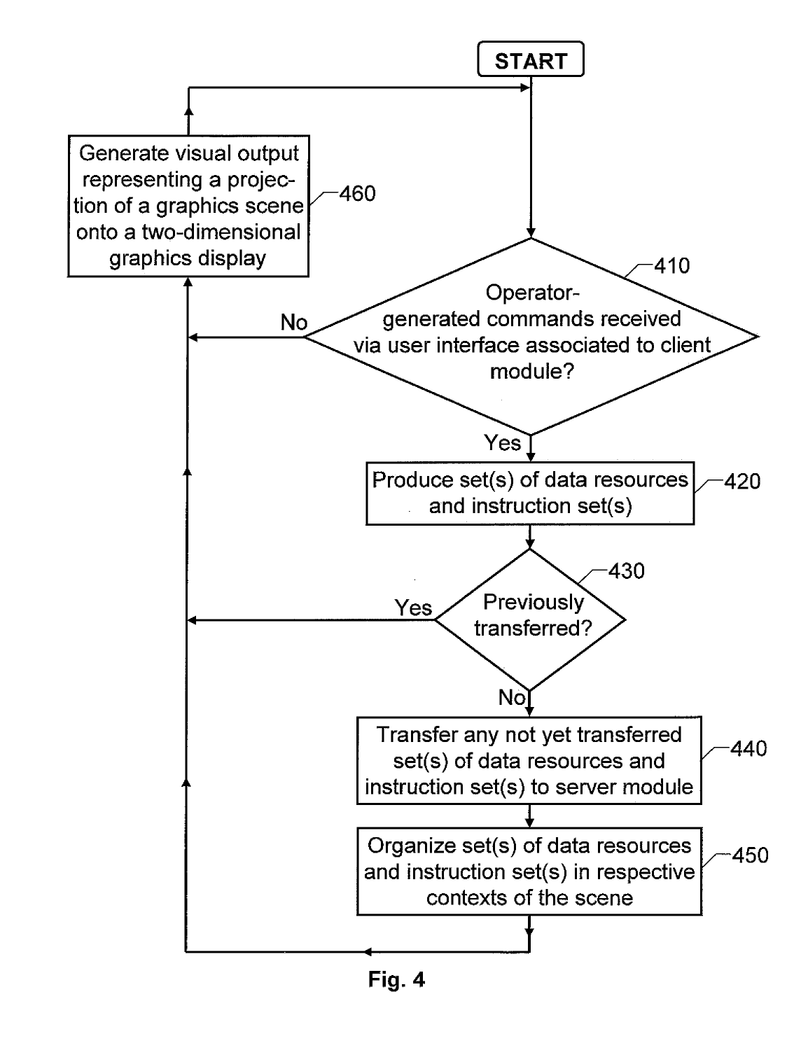

To sum up, the general method of processing computer graphics according to the invention will now be described with reference to the flow diagram in FIG. 4.

An initial step 410 investigates whether or not operator-generated commands have been received. It is here presumed that the commands pertain to a data structure that describes a graphics scene, and that the commands are entered via one or more user interfaces associated to a client module, such as a keyboard, a cursor control means or a touch screen. If it is found that no such commands are received, the procedure loops back via a step 460. Otherwise, a step 420 follows, which produces at least one set of data resources and at least one instruction set based on the commands. Each resource in the set of data resources represents a given graphical content of the scene, and each instruction set describes interrelationships between the resources in the set of data resources.

Subsequently, a step 430 investigates whether or not at least one data resource in the set of data resources has been previously transferred from the client module to the server module. If it is found that all the data produced in step 420 is equivalent to what has already been transferred to the server module earlier, the procedure loops to step 460. Otherwise, a step 440 follows. This step transfers those sets of data resources and instruction sets produced in step 420 which have not previously been transferred to the server module.

Then, a step 450 organizes the data resources and the instructions in at least one data area of the server module, such that each data area contains an amount of data which relates to a given context of the scene. Hence, the data is organized as a set of data resources and an instruction set (142, 152, 162) associated thereto. Thereafter, step 460 follows.

Step 460 generates visual output data adapted for presentation on the graphics display based on the set of data resources and the instruction set presently stored in the server module. I.e. the visual output data may be based on data resources and instruction sets transferred in the latest step 440 as well as on information transferred earlier. In any case, the visual output data is generated by means of at least one rendering kernel in the server module. After that, the procedure returns to step 410.

All of the process steps, as well as any sub-sequence of steps, described with reference to the FIG. 4 above may be controlled by means of a programmed computer apparatus. Moreover, although the embodiments of the invention described above with reference to the drawings comprise computer apparatus and processes performed in computer apparatus, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a CD (Compact Disc) or a semiconductor ROM, an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

The term “comprises/comprising” when used in this specification is taken to specify the presence of stated features, integers, steps or components. However, the term does not preclude the presence or addition of one or more additional features, integers, steps or components or groups thereof.

The reference to any prior art in this specification is not, and should not be taken as, an acknowledgement or any suggestion that the referenced prior art forms part of the common general knowledge in Australia, or any other country.

The invention is not restricted to the described embodiments in the figures, but may be varied freely within the scope of the claims.

1. A graphics processing system comprising:
at least one user interface adapted to receive operator-generated commands concerning a data structure describing a graphics scene;
at least one rendering element adapted to produce visual output data representing a projection of the scene onto a two-dimensional graphics display;
a server module associated with a memory means having at least one data area which each is adapted to store an amount of data relating to a given context of the scene, each amount of data being organized as:
a set of data resources wherein each resource represents a given graphical content of the scene; and
an instruction set describing interrelationships between the resources in the set of data resources, the server module implementing at least one rendering kernel configured to generate the visual out put data based on the set of data resources and the instruction set, the visual output data having a format adapted for presentation on the graphics display; and
a client module adapted to:
receive the operator-generated commands, based thereon
produce the at least one set of data resources and the at least one instruction set,
and transfer the data resources and the at least one instruction set to the server module.

2. The system according to claim 1, wherein the client module is adapted to, in response to the operator-generated command:
investigate whether or not the command represents at least one data resource in addition to any data resources having been previously transferred from the client module to the server module for inclusion into at least one of the at least one set of data resources, and only if the command represents at least one such additional data resource
transfer the at least one data resource to the server module.

3. The system according to claim 1, wherein the client module and the server module are implemented in a common data-processing apparatus.

4. The system according to claim 1, wherein the client module is implemented in a first data-processing apparatus and the server module is implemented in a second data-processing apparatus.

5. The system according to claim 4, comprising at least two client modules implemented in a respective data-processing apparatus which each is adapted to transfer data resources and instructions to a data-processing apparatus implementing the server module.

6. The system according to claim 4, comprising at least two server modules implemented in a respective data-processing apparatus which each is adapted to receive data resources and instructions from at least one client module.

7. The system according to claim 1, wherein the graphics scene comprises at least one renderable entity, and at least one instruction in one of the instruction sets is adapted to describe a forming of the at least one renderable entity in the visual output data based on a set of data resources.

8. The system according to claim 1, wherein the instructions in the instruction sets are categorized into:
local instructions adapted to influence a specifically identified subset of data resources in a set of the data resources; and
global instructions adapted to influence all data resources in the graphics scene.

9. The system according to claim 1, wherein the data resources in the set of data resources comprises at least one of: a transform matrix, a mesh, a texture and a shader.

10. The system according to claim 1, wherein each of the at least one data area is exclusively associated with a given client module.

11. The system according to claim 1, wherein at least one first data resource in a first set of data resources of said sets of data resources is configured to be shared with at least one second data resource in a second set of data resources of said sets of data resources, the at least one first and second data resource representing the same graphical content of the scene however associated with different instruction sets.

12. The system according to claim 1, wherein the server module is adapted to:
receive the instruction set and the set of data resources on at least one first respective predefined format,
convert at least one of the instruction set and the set of data resources into a second format; and
store the converted data in the memory means.

13. The system according to claim 12, wherein the server module is adapted to generate the visual output data contemporaneously with converting the at least one of the instruction set and the set of data resources into the second format.

14. The system according to claim 1, wherein:
the server module comprises a user interface adapted to enable modification of the rendering kernel into a customized version of the rendering kernel; and
the set of data resources and the instruction set stored in the data area of the memory means of the server module are organized in a data structure being adapted to be interoperable with the customized version of the rendering kernel.

15. A method of processing computer graphics comprising:
receiving operator-generated commands concerning a data structure describing a graphics scene via at least one user interface associated to a client module;
producing at least one set of data resources and at least one instruction set based on the commands, each resource in the at least one set of data resources representing a given graphical content of the scene, and each instruction set describing interrelationships between there sources in the set of data resources;
transferring the data resources and the at least one instruction set to a server module;
organizing, in a memory means of the server module, the data resources and the instructions in at least one data area such that each data area contains an amount of data which relates to a given context of the scene and the data is organized as:
a set of data resources; and
an instruction set associated thereto; and
generating the visual output data based on the set of data resources and the instruction set by means of at least one rendering kernel in the server module, the visual output data having a format adapted for presentation on the graphics display.

16. The method according to claim 15, comprising:
investigating, in response to the operator-generated command, whether or not the command represents at least one data resource in addition to any data resources having been previously transferred from the client module to the server module for inclusion into at least one of the at least one set of data resources, and only if the command is found to represent at least one such additional data resource,
transferring the at least one data resource to the server module.

17. The method according to claim 15, wherein the graphics scene comprises at least one renderable entity, and at least one instruction in one of the instruction sets is adapted to describe a forming of the at least one renderable entity in the visual output data based on a set of data resources.

18. The method according to claim 15, wherein the instructions in the instruction sets are categorized into:
local instructions adapted to influence a specifically identified subset of data resources in a set of the data resources; and
global instructions adapted to influence all data resources in the graphics scene.

19. The system according to claim 15, wherein the data resources in the set of data resources comprises at least one of: a transform matrix, a mesh, a texture and a shader.

20. The method according to claim 15, comprising:
receiving the instruction set and the set of data resources in the server module on at least one first respective predefined format;
converting in the server module at least one of the instruction set and the set of data resources into a second format; and
storing the converted data in the memory means of the server module.

21. The method according to claim 20, wherein the server module is adapted to generate the visual output data contemporaneously with converting the at least one of the instruction set and the set of data resources into the second format.

22. The method according to claim 15, the set of data resources and the instruction set stored in the data in the memory means of the server module being organized in a data structure which is adapted to be interoperable with at least one customized version of the rendering kernel, and the method comprising receiving in the server module user instructions modifying the rendering kernel into a customized version of the rendering kernel.

23. A computer program loadable into the memory of a data-processing apparatus, comprising software for controlling the operations of claim 15 when said program is run on the data-processing apparatus.

24. A computer readable medium, having a program recorded thereon, where the program is to make a data-processing apparatus control the operations of claim 15 when the program is loaded into the data-processing apparatus.
